(19) United States
(12) Patent Application Publication
(10) Pub. No.: US 2024/0345782 A1
(43) Pub. Date: Oct. 17, 2024

(54) INFORMATION PROCESSING APPARATUS, COMMUNICATION CONTROL METHOD, AND NON-TRANSITORY COMPUTER-READABLE STORAGE MEDIUM

(71) Applicant: CANON KABUSHIKI KAISHA, Tokyo (JP)

(72) Inventor: Akira Nakamura, Tokyo (JP)

(21) Appl. No.: 18/616,488

(22) Filed: Mar. 26, 2024

(30) Foreign Application Priority Data
Apr. 13, 2023 (JP) 2023-065899

(51) Int. Cl. G06F 3/12; H04W 76/10

(52) U.S. Cl. CPC G06F 3/1236; G06F 3/1208; G06F 3/1225; G06F 3/1239; G06F 3/1286; G06F 3/1288; H04W 76/10

(57) ABSTRACT

An information processing apparatus that communicates with an external apparatus controls to perform wireless communication with a communication apparatus by a first communication method of performing communication without intervention of an external access point, acquires, from the communication apparatus, specification information for specifying the communication apparatus by communication of the first communication method, controls to start, after the specification information is acquired, wireless communication of a second communication method as a communication method via the external access point, and controls to transmit the acquired specification information to a specific server system connected to an external network by the started communication of the second communication method.

### BACKGROUND OF THE INVENTION

### Field of the Invention

The present invention relates to an information processing apparatus, a communication control method, and a non-transitory computer-readable storage medium.

### Description of the Related Art

As a Web service using the Internet, there is provided a consumable automatic ordering system in which a printer notifies a Web server of the remaining amount of a consumable such as ink and paper, and the Web server automatically orders the consumable from a store based on the remaining amount information of the consumable. Furthermore, a flat-rate Web service in which the system lends a usable printer to a user and a consumable can be exchanged at a flat rate including the usage fee of the main body has appeared on the market. In some flat-rate Web services, the use of the printer is restricted in a state in which the printer is not registered in the Web service. In this case, to use the printer, it is necessary to perform processing of connecting the printer to the Internet and processing of registering the printer in the Web service, and it is necessary to perform these processes at the time of a setup of the printer. These processes are performed by an information processing apparatus such as a PC or a smartphone connected to the Internet.

However, depending on the security setting of the network connected to the information processing apparatus, communication between devices connected to the network may not be permitted. For example, in a case where devices are connected to different networks, communication between the devices is often restricted by the setting of a network device. A wireless LAN access point having a privacy separator function can set not to permit communication between wireless clients connected to a wireless LAN. If this function is enabled, even devices connected to the same network cannot communicate with each other.

In this case, even if an information processing apparatus and a printer as wireless clients are connected to the network, the information processing apparatus and the printer cannot communicate with each other. Therefore, it is impossible to execute communication processing for the use of the printer after a setup of the printer, such as processing necessary for the setup of the printer including registration processing in the Web service and transmission of print data. Japanese Patent Laid-Open No. 2019-193143 describes a method of establishing connection between an information processing apparatus and a communication apparatus without intervention of an external apparatus while maintaining connection between the communication apparatus and the external apparatus, based on determination that it is impossible to execute communication between the communication apparatus and the information processing apparatus via an access point.

However, if, for example, a connection interface (I/F) for connection of the information processing apparatus to a network is only a wireless I/F, it is impossible to maintain connection to the external apparatus that provides Internet connection and connection to the communication apparatus without intervention of the external apparatus at the same time. In this case, in the conventional technique, while the information processing apparatus is connected to the printer as the communication apparatus, Internet connection of the printer is always maintained but the Internet connection of the information processing apparatus is disconnected. On the other hand, in the registration processing in the Web service, it may be necessary to transmit, to a server for Web service registration, information acquired by the information processing apparatus from the printer. If the Internet connection of the information processing apparatus is disconnected, this processing cannot be executed. Therefore, while the setup of the printer is executed, the user who operates the information processing apparatus needs to appropriately switch the connection destination of the information processing apparatus to the external apparatus or the printer, which is cumbersome.

### SUMMARY OF THE INVENTION

According to the present invention, even if communication between client terminals connected to a network is not permitted, registration and a setup of a printer are readily performed by selectively using connection to the network and direct connection between the devices.

The present invention has the following arrangement. According to one aspect of the present invention, there is provided a non-transitory computer-readable storage medium storing one or more programs configured to cause at least one memory and at least one processor of an information processing apparatus to function as: a first communication control unit configured to perform control to perform wireless communication with a communication apparatus by a first communication method of performing communication without intervention of an external access point; an acquisition unit configured to acquire, from the communication apparatus, specification information for specifying the communication apparatus by communication of the first communication method; a second communication control unit configured to perform control to start, after the acquisition unit acquires the specification information, wireless communication of a second communication method as a communication method via the external access point; and a first transmission control unit configured to perform control to transmit the specification information acquired by the acquisition unit to a specific server system connected to an external network by the communication of the second communication method started by the control of the second communication control unit.

According to the present invention, even if communication between devices connected to a network is not permitted, registration and a setup of a printer can readily be performed by selectively using connection to the network and direct connection between the devices.

Further features of the present invention will become apparent from the following description of exemplary embodiments with reference to the attached drawings.

### BRIEF DESCRIPTION OF THE DRAWINGS

FIG. 1 is a view showing a system configuration according to an embodiment;

FIG. 2 is a block diagram showing an example of the hardware arrangement of a computer;

FIG. 3 is a block diagram showing an example of the hardware arrangement of a printer;

FIG. 4 is a block diagram showing an example of the hardware arrangement of a server;

FIG. 5 is a flowchart illustrating processing of a setup application according to the embodiment;

FIG. 6 is a flowchart of network communication processing according to the embodiment;

FIGS. 7A and 7B illustrate a sequence chart showing the procedure of processing among the PC, the printer, the management server, and an AP according to the embodiment; and

FIG. 8 is a flowchart of a modification of the processing of the setup application according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

A printer that prints an image will be exemplified as an image processing apparatus according to the embodiments. Furthermore, a personal computer (PC) will be exemplified as an information processing apparatus that performs wireless setting processing for the image processing apparatus according to the embodiments. However, the present invention is not limited to this. The information processing apparatus may be an information processing terminal such a smartphone or a tablet, and the processing of the information processing apparatus according to the embodiments may be applied to various devices such as a digital camera.

### First Embodiment

### <System Configuration>

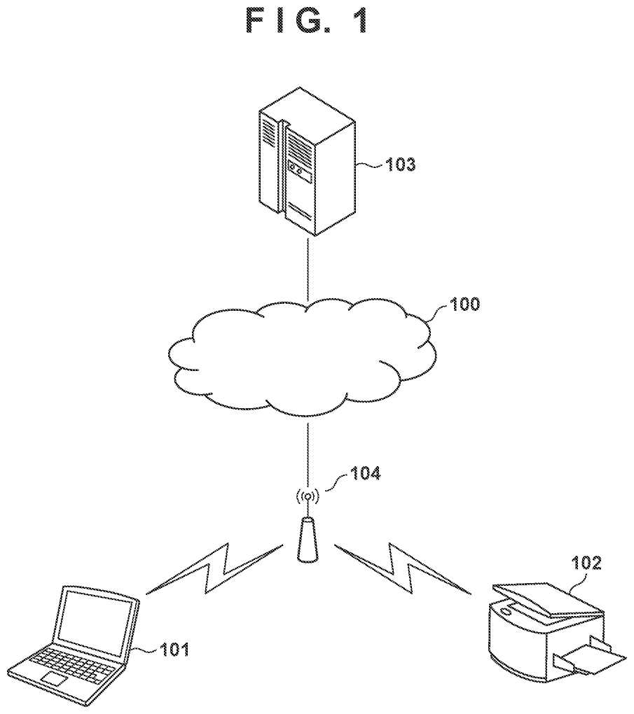

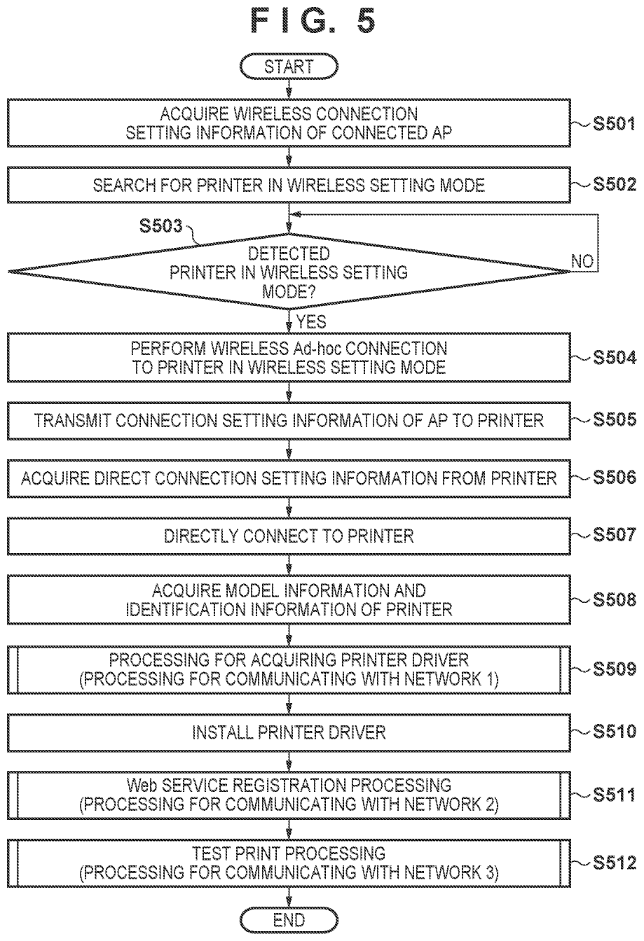

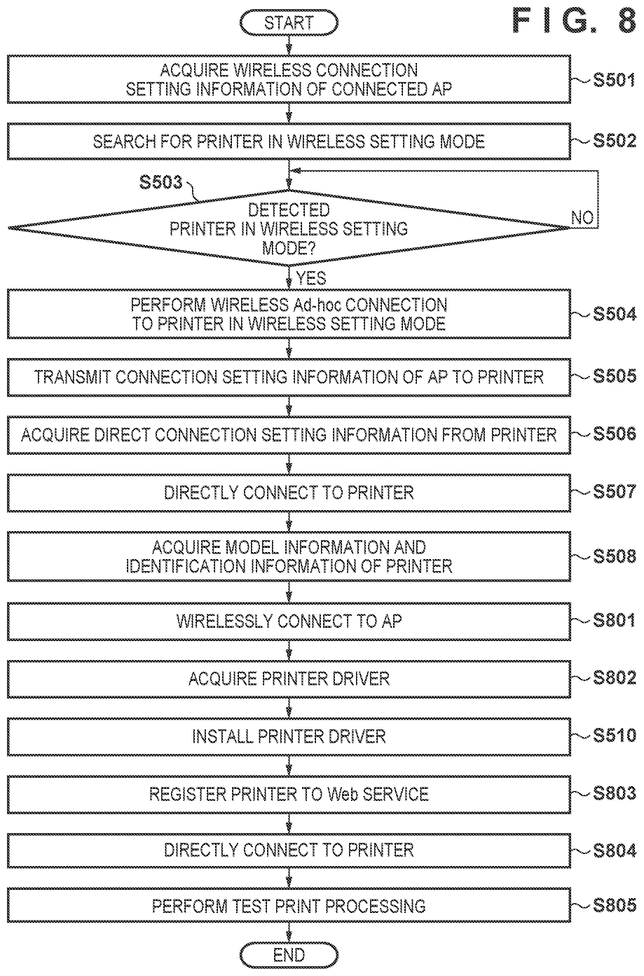

FIG. 1 is a view showing an example of a system configuration according to the embodiment. The information processing system of this embodiment includes a personal computer (PC) 101 as an information processing apparatus, a printer 102 as an image processing apparatus, and a management server 103. The PC 101 executes a communication control method of a procedure shown in FIG. 5 or 8.

Referring to FIG. 1, the PC 101 and the printer 102 are connected to an access point (AP) 104 by a wireless local area network (LAN). The wireless LAN will sometime be referred to as a wireless network hereinafter. Although not shown in FIG. 1, a router or gateway is connected between the AP 104 and the Internet 100. A network connected to the wireless LAN by the router or gateway will sometimes be referred to as an external network hereinafter. The PC 101 and the printer 102 can be connected to the Internet 100 via the AP 104. At this time, a network connectable to the Internet 100 connected to the PC 101 and the printer 102 will be referred to as the first network in this embodiment. That is, in the example shown in FIG. 1, the first network is a network created by a device connected to the AP 104 by the wireless LAN. The management server 103 is connected to the Internet 100. The management server 103 manages information transmitted from the PC 101 and the printer 102. Each communication operation is controlled via a protocol such as HTTP or XMPP.

The PC 101 can communicate with the printer 102 via the AP 104. Such method of performing connection via the AP is called infrastructure connection or an infrastructure mode. The AP 104 may have a function of interrupting communication between devices connected to the AP 104 as a security setting. This security setting is called a privacy separator function, and is switched between an enable state and a disable state by changing the setting of the AP 104. In a case where the privacy separator function is in the enable state, even if the PC 101 and the printer 102 are connected to the AP 104, the PC 101 and the printer 102 can each access the Internet via the AP 104 but cannot communicate with each other. That is, in the wireless network in which the privacy separator function is enabled, wireless clients connected to the one wireless network cannot communicate with each other.

On the other hand, there is provided a connection method called wireless ad hoc connection (ad hoc connection) or an ad hoc mode in which only two devices can communicate with each other without intervention of the AP. The PC 101 and the printer 102 can perform peer-to-peer connection (P2P connection) by wireless ad hoc connection. Note that while performing wireless ad hoc connection, each of the PC 101 and the printer 102 uses a wireless LAN interface for the wireless ad hoc connection, and cannot communicate with other devices. Therefore, the wireless ad hoc connection is often used as temporary connection.

In addition, there is provided Wi-Fi Direct® (to be referred to as direct connection hereinafter) as another method of directly, wirelessly connecting the PC 101 and the printer 102 without intervention of the network. Direct connection is a method of implementing direct connection by providing the function of the AP to a terminal by a software AP. Direct connection according to this embodiment indicates direct connection in which the printer 102 is caused to function as an AP. At this time, a network in which the PC 101 and the printer 102 can directly be connected (that is, P2P-connected) to communicate with each other will be referred to as the second network in this embodiment. If the printer 102 is directly connected to the PC 101, the printer 102 can be connected to the AP 104 at the same time (that is, in parallel). This operation is called a simultaneous operation. In other words, the simultaneous operation indicates an operation of causing the printer 102 to simultaneously execute an operation as a master unit (group owner or access point) and an operation as a slave unit.

### <Hardware Arrangement of Computer>

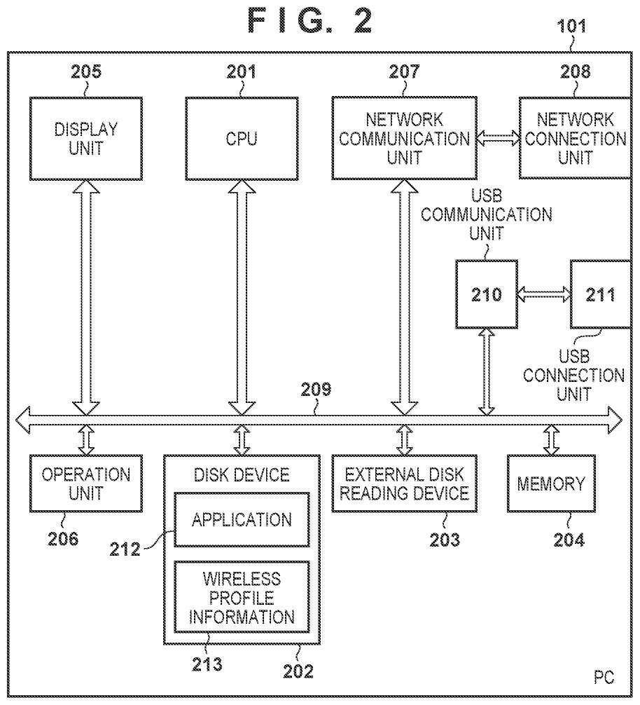

FIG. 2 is a block diagram showing an example of the hardware arrangement of the PC 101. The PC 101 includes a processor (CPU) 201, a disk device 202, an external disk reading device 203, a memory 204, a display unit 205, and an operation unit 206. The PC 101 further includes a network communication unit 207, a network connection unit 208, a USB communication unit 210, and a USB connection unit 211.

The CPU 201 is a central processing unit for controlling each unit of the PC 101. The disk device 202 stores applications 212 to be read out by the CPU 201 and an Operating System (to be referred to as an OS hereinafter) (not shown) as well as various files such as wireless profile information 213 (to be described later). The applications 212 include a setup application for setting the printer 102. The external disk reading device 203 is a device for reading out data such as files stored in an external storage medium such as an SD card. The memory 204 is formed by a RAM or the like, and the CPU 201 temporarily stores or buffers data in the memory 204, as needed. The display unit 205 is formed by, for example, an LCD, and displays various kinds of information. The operation unit 206 includes a keyboard and a mouse used by the user to perform various input operations.

The network communication unit 207 is connected to the AP 104 via the network connection unit 208. That is, the network communication unit 207 is connected to a network such as the Internet 100 via the network connection unit 208 to perform various communication operations. The network communication unit 207 supports a wired LAN or a wireless LAN. In a case where the network communication unit 207 supports the wired LAN, the network connection unit 208 serves as a connector for connecting a wired LAN cable. In a case where the network communication unit 207 supports the wireless LAN, the network connection unit 208 serves as an antenna. The USB communication unit 210 is connected to various peripheral apparatuses (for example, the printer 102) via the USB connection unit 211 to perform various communication operations. The above-described units (201 to 207 and 210) are interconnected by a bus 209.

The wireless profile information 213 indicates connection setting information to the AP to which the PC 101 has been connected in the past, and is information including identification information (SSID and the like) of the AP and authentication information (password and the like) to be used for authentication processing at the time of connection. The wireless profile information 213 is stored or managed in the disk device 202 when the CPU 201 executes the OS stored in the disk device 202.

### <Hardware Arrangement of Printer>

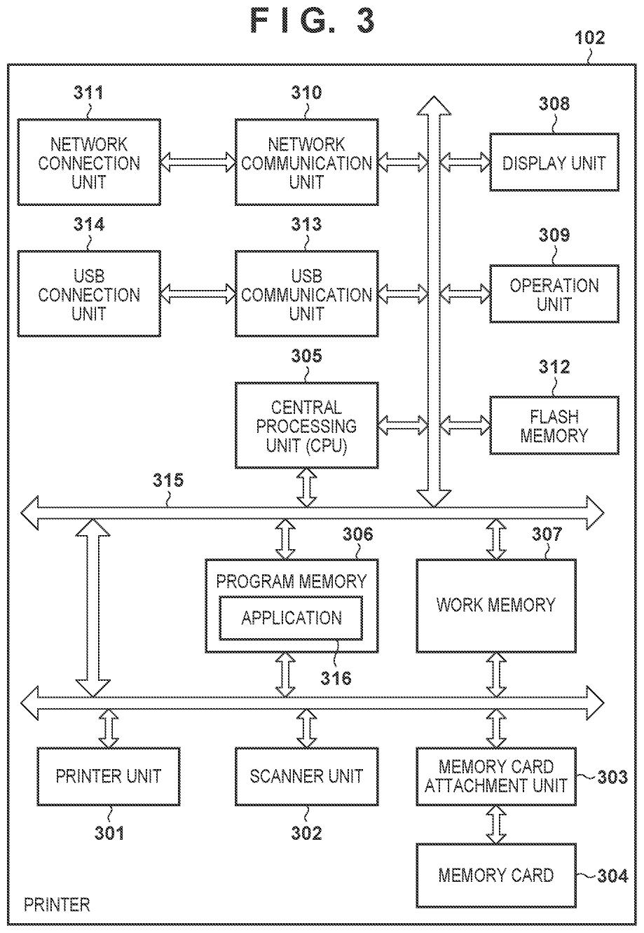

FIG. 3 is a block diagram showing an example of the hardware arrangement of the printer 102. The printer 102 includes a printer unit 301, a scanner unit 302, a memory card attachment unit 303, and a memory card 304. The printer 102 further includes a CPU 305, a program memory 306, a work memory 307, a display unit 308, an operation unit 309, a network communication unit 310, a network connection unit 311, a flash memory 312, a USB communication unit 313, and a USB connection unit 314. In this embodiment, the printer 102 serving as a multifunctional apparatus will be described as an example of the image processing apparatus but a copy machine, a facsimile apparatus, or the like may be used. Alternatively, a printer having no scanner function may be used. In the printer 102, a print function is implemented by the printer unit 301, a scanner function is implemented by the scanner unit 302, and a storage function is implemented by the memory card attachment unit 303 and the memory card 304. The printer unit 301 prints externally received image data or image data stored in the memory card 304 on a print sheet by a printing method such as an inkjet method or an electrophotographic method. In addition, the printer unit 301 manages ink information including a remaining ink amount and paper information including the number of stacked sheets.

The scanner unit 302 optically reads a document set on a document table (not shown), converts it into electronic data, and then transmits image data converted into a designated file format to an external apparatus via the network or stores the image data in a save area (not shown) such as an HDD. Copying is implemented when image data generated by reading, by the scanner unit 302, a document placed on the document table is transferred to the printer unit 301 and the printer unit 301 prints the image data on a print sheet. The memory card 304 attached to the memory card attachment unit 303 stores various file data. The file data can be read out from an external apparatus via the network and edited. The file data can also be stored in the memory card 304 from an external apparatus.

The CPU 305 is a central processing unit for controlling each unit in the printer 102. The program memory 306 is formed by a ROM or the like, and stores various program codes and an application 316 for communicating with a server apparatus. The application 316 includes programs for implementing direct connection, and the programs include a program of a software AP. The application 316 also includes a program for accessing the printer unit 301 to acquire consumable information of ink, paper, and the like. The work memory 307 is formed by a RAM or the like, and temporarily stores or buffers image data, a job log, and the like at the time of execution of each Web service.

The display unit 308 is formed by, for example, an LCD, and displays various kinds of information. The operation unit 309 is formed by switches and the like used by the user to perform various input operations. The network communication unit 310 is connected to the AP 104 via the network connection unit 311. That is, the network communication unit 310 is connected to a network such as the Internet 100 via the network connection unit 311 to perform various communication operations. Each communication operation is controlled via a protocol such as HTTP or XMPP. The network communication unit 310 supports a wired LAN or a wireless LAN. In a case where the network communication unit 310 supports the wired LAN, the network connection unit 311 serves as a connector for connecting a wired LAN cable. In a case where the network communication unit 310 supports the wireless LAN, the network connection unit 311 serves as an antenna. The flash memory 312 is a nonvolatile memory for storing image data received by the network communication unit 310 and the like. The USB communication unit 313 is connected to various peripheral apparatuses (for example, the PC 101) via the USB connection unit 314 to perform various communication operations. The above-described units are interconnected by a bus 315.

The program memory 306 also stores a unique SSID. The unique SSID is uniquely decided for, for example, the manufacturer of the printer or a printer model. Then, the network connection unit 311 of the printer 102 can operate as an AP corresponding to the unique SSID.

P2P communication by wireless ad hoc connection according to this embodiment may be implemented by a communication method in which no AP is used or a method in which the PC 101 or the printer 102 operates as an AP. For example, the network connection unit 311 operates as the AP corresponding to the unique SSID stored in the program memory 306. In this case, the network connection unit 208 of the PC 101 is connected to the network connection unit 311 of the printer 102 functioning as the AP corresponding to the unique SSID. In this method, the PC 101 can be connected (directly connected) to the printer 102 by the same connection processing as that for the external AP 104. Therefore, even if the PC 101 cannot execute processing for ad hoc connection without intervention of the AP, the PC 101 can perform P2P communication with the printer 102. In addition, the printer 102 functioning as the AP for direct connection can perform simultaneous connection for performing, as a slave unit, connection to the AP 104 simultaneously with direct connection to the PC 101.

### <Hardware Arrangement of Server>

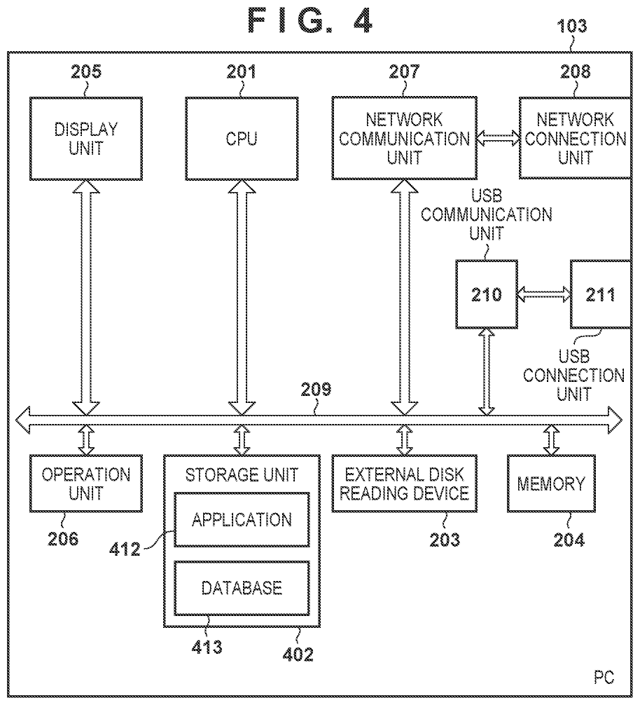

FIG. 4 is a block diagram showing the hardware arrangement of the management server 103. Note that the same reference numerals as in FIG. 2 denote the same components as those of the PC 101 shown in FIG. 2 and a description thereof will be omitted. A disk device 402 of the management server 103 stores an application 412 to be read out by the CPU 201, a database 413, and an OS as well as various files. The application 412 performs consumable ordering processing in a automatic consumable ordering system (to be described later) and processing of registering a user and a printer in a Web Service.

### <Sequence>

Next, processing from the start of a setup of the printer 102 until completion of registration in a Web service and the setup of the printer 102 will be described.

As a Web service in this embodiment, a flat-rate Web service that lends the printer 102 to the user and exchanges a consumable at a flat rate including the usage fee of the main body will be exemplified. This Web service uses the automatic consumable ordering system in which the printer 102 notifies the management server 103 of the remaining amount of a consumable such as ink and paper and the management server 103 automatically orders the consumable from a store based on the remaining amount information of the consumable. In this Web service, to use the functions of the printer such as a print function and a scan function, registration in the Web service is required, and the user cannot start to use the printer 102 in a state in which registration in the Web service is not performed. The printer 102 periodically communicates with the management server 103 and notifies the management server 103 of the remaining amount of the consumable such as ink and paper. In accordance with contract contents at the time of registration in the Web service, the management server 103 automatically orders the consumable or, if the use upper limit is reached, sends a function stop instruction to the printer 102 or charges an extra fee to the user. If the printer 102 does not periodically communicate with the management server 103 because, for example, the printer 102 is disconnected from the network, the printer 102 may stop the function to prevent unauthorized use.

When the user who rents the printer 102 uses the printer 102, the user first performs a setup of the printer 102. In the setup, setting of communication between the printer 102 and the management server 103, setting of communication between the printer 102 and the PC 101, registration of the printer 102 in the PC 101, and the like are performed, and then registration of the printer 102 in the Web service is performed. After the setup, the PC 101 can transmit print data to the printer 102 to execute printing, and the printer 102 can perform necessary communication with the management server 103.

An example of the processing from the start of the setup until completion of registration in the Web service and the setup of the printer 102 will be described in detail. At the start of the setup, the PC 101 is already connected to the AP 104 via the network connection unit 208, and can be connected to the Internet 100 via the AP 104. The printer 102 is operating in a wireless setting mode, and causes the network connection unit 311 to operate as the AP with the unique SSID stored in advance.

The wireless setting mode may be started on condition that the user sends an instruction to shift to the wireless setting mode or may be started on another condition. For example, the printer 102 may temporarily shift to the wireless setting mode on condition that, for example, the printer 102 is not connected wirelessly at the time of power-on or the printer 102 is powered on for the first time after purchase. The privacy separator function of the AP 104 is enabled as a security setting, and devices connected to the AP 104 cannot communicate with each other. Assume that the setup application performs acquisition and installation of a printer driver, network connection processing of the printer, and registration processing in the Web service according to this embodiment. The setup application is one of the applications 212 stored in the disk device 202 of the PC 101.

### Setup Processing

FIG. 5 is a flowchart illustrating the operation of the setup application according to this embodiment. For example, the setup application is provided to the user together with the printer 102, and installed to be executable. Along with the installation of the setup application, the unique SSID assigned to the printer 102 may be stored in the PC 101.

The setup application included in the applications 212 of the PC 101 displays a predetermined screen on the display unit 205. When the user performs a predetermined instruction on the predetermined screen, for example, the user presses a button to start processing for the setup, the setup application starts the processing for the setup of the printer 102. The execution constituent of this processing is the CPU 201 as a hardware component, but the following description assumes that the setup application executed by the CPU 201 is the main constituent.

In step S501, the setup application acquires wireless connection setting information of the AP 104 connected to the PC 101. More specifically, the setup application acquires the wireless profile information 213 including the SSID of the AP 104 from the PC 101.

In step S502, the setup application searches for the printer 102 in the wireless setting mode. More specifically, the printer 102 operating in the wireless setting mode periodically broadcasts a beacon including the unique SSID. The setup application causes the PC 101 to detect the beacon corresponding to the unique SSID, and searches for the printer 102 operating as an AP.

If, as a result of step S502, the printer in the wireless setting mode is detected (YES in step S503), the setup application disconnects, in step S504, the PC 101 from the AP 104, and performs wireless ad hoc connection of the PC 101 to the printer 102. After wireless ad hoc connection between the PC 101 and the printer 102 is established, the PC 101 and the printer 102 can communicate with each other.

In step S505, the setup application refers to the wireless profile information 213, and transmits, to the printer 102, information for instructing wireless connection to the AP 104, that includes the wireless connection setting information such as the SSID of the AP 104. Upon receiving the information, the printer 102 is connected to the AP 104 using the wireless connection setting information to the AP 104, that is included in the received information.

In step S506, the setup application acquires direct connection setting information from the printer 102. The direct connection setting information includes setting information for direct connection to the printer 102, that includes the SSID.

In step S507, the setup application directly connects the PC 101 to the printer 102 using the direct connection setting information acquired in step S506.

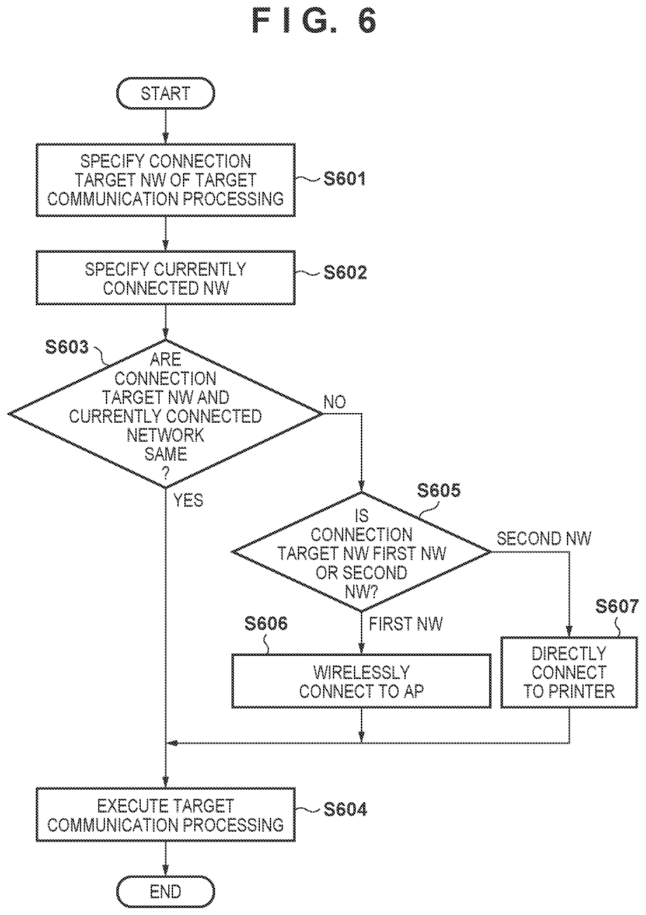

In step S508, the setup application wirelessly communicates with the printer 102 to acquire model information of the printer 102 and identification information of the printer 102 such as a serial number. The acquired model information and identification information are information necessary to specify the printer 102 and provide the service. Processing that is executed by the setup application and requires communication with the first network or the second network will be referred to as network communication processing hereinafter. The network communication processing is executed in each of steps S509, S511, and S512. In each step, communication processing to be executed and a connection target network are designated by parameters, and then the procedure shown in FIG. 6 is called. FIG. 6 shows a flowchart of the network communication processing according to this embodiment. Before calling the network communication processing shown in FIG. 6, a combination of pieces of information representing contents of the communication processing to be executed by the setup application and the connection target network is stored in a volatile memory area (for example, the memory 204) that can be accessed by the setup application.

In step S601, the setup application specifies the connection target network of the execution target network communication processing. In this specifying processing, the setup application refers to the information representing the connection target network recorded before calling the network communication processing to specify one of the first network and the second network as the connection target network.

In step S602, the setup application specifies the network connected to the PC 101. In this specifying processing, the setup application specifies one of the first network and the second network as the currently connected network from identification information such as the SSID of the network wirelessly connected to the PC 101. If the PC 101 is wirelessly connected to the AP 104, the first network is specified as the currently connected network, and if the PC 101 is directly connected to the printer 102, the second network is specified as the currently connected network.

In step S603, the setup application determines whether the connection target network and the network connected to the PC 101, that are respectively specified in steps S601 and S602, indicate the same network.

If it is determined in step S603 that the networks indicate the same network, the setup application executes, in step S604, the execution target network communication processing. The execution target network communication processing is specified based on the information representing the contents of the communication processing stored in the memory.

If it is determined in step S603 that the networks are different networks, the setup application determines, in step S605, which of the first network and the second network corresponds to the connection target network specified in step S601.

If it is determined in step S605 that the connection target network is the first network, the setup application disconnects, in step S606, the PC 101 from the currently connected network, and connects the PC 101 to the second network. More specifically, the setup application wirelessly connects the PC 101 to the AP 104 using the wireless connection setting information such as the SSID of the AP 104 included in the wireless profile information 213. After that, in step S604, the setup application executes the execution target network communication processing.

If it is determined in step S605 that the connection target network is the second network, the setup application disconnects, in step S607, the PC 101 from the currently connected network, and connects the PC 101 to the first network. More specifically, the setup application directly connects the PC 101 to the printer 102 using the direct connection setting information acquired in step S506. After that, in step S604, the setup application executes the execution target network communication processing.

As described above, in this embodiment, the determination processes are performed in steps S601 and S602. Then, if the connection target network is different from the currently connected network, the PC 101 is connected to an appropriate network in step S606 or S607. This can connect the PC 101 to an appropriate network at an appropriate timing in accordance with the processing to be executed.

Referring back to the flowchart of FIG. 5, in step S509, the setup application performs, as the first network communication processing, a series of processes for acquiring an appropriate printer driver based on the model information of the printer 102 acquired in step S508. This is obtained by applying the processing of the flowchart shown in FIG. 6 to the printer driver acquisition processing. The connection target network is the first network and the execution target processing is acquisition of the driver of the printer 102. The pieces of information representing these are stored in the memory 204 and then the processing shown in FIG. 6 is executed.

As a result of specifying (step S601) the connection target network in step S509, the printer connection target network is specified as the first network.

As a result of specifying (step S602) the currently connected network in step S509, the currently connected network is specified as the second network.

The connection target network and the currently connected network are different in step S509 (NO in step S603), and the connection target network is the first network (the first NW in step S605). Thus, the PC 101 is disconnected from direct connection to the printer 102, and is wirelessly connected to the AP 104 using the wireless connection setting information such as the SSID of the AP 104 included in the wireless profile information 213 (step S606).

As the network communication processing in step S509, the setup application downloads, from the Web server via the Internet 100, the printer driver whose model information matches that of the printer 102 (step S604).

In step S510, the setup application installs the printer driver acquired in step S509 in the PC 101. After the end of the installation of the printer driver, the setup application creates a print queue linked with the printer driver. The PC 101 can transmit image data to the printer 102 via the created print queue, and transmit a print instruction.

In step S511, the setup application starts, as the second network communication processing, a series of processes for Web service registration for registering the printer 102 in the management server 103. This is obtained by applying the processing of the flowchart shown in FIG. 6 to the Web service registration processing. The connection target network is the first network and the execution target processing is registration of the printer 102 in the Web service. The pieces of information representing these are stored in the memory 204 and then the processing shown in FIG. 6 is executed.

As a result of specifying (step S601) the connection target network in step S511, the printer connection target network is specified as the first network.

As a result of specifying (step S602) the currently connected network in step S511, the currently connected network is specified as the first network.

Since the connection target network and the currently connected network are the same in step S511, it is determined that it is unnecessary to change the connection destination of the PC 101 (YES in step S603).

As the network communication processing in step S511, the setup application performs Web service registration processing (step S604). More specifically, the setup application communicates with the management server 103 to transmit the identification information of the printer 102 such as a serial number acquired in step S508. The identification information of the printer 102 is recorded in the database 413 of the management server 103, and the printer 102 is recorded as a Web service registration preparation state in the database 413. Depending on the type of the Web service, additional information, such as the address of the user and credit card information, necessary to use the Web service is also recorded in the database 413 in linkage with the identification information of the printer 102. The addition information may be input at the time of purchase of the printer or after the end of the processing of the setup application according to this embodiment. The registration processing by the management server 103 may be performed by the management server 103 alone, or by an overall system formed by a plurality of servers.

After that, as a result of the series of communication operations performed between the management server 103 and the printer 102 (to be described later), the printer 102 is set in a Web service usable state.

In step S512, the setup application starts, as the third network communication processing, a series of processes for test printing that allows the user to confirm completion of the setup of the printer 102. This is obtained by applying the processing of the flowchart shown in FIG. 6 to test printing processing. The connection target network is the second network and the execution target processing is test printing by the printer 102. The pieces of information representing these are stored in the memory 204 and then the processing shown in FIG. 6 is executed.

As a result of specifying (step S601) the connection target network in step S512, the printer connection target network is specified as the second network.

As a result of specifying (step S602) the currently connected network in step S512, the currently connected network is specified as the first network.

The connection target network and the currently connected network are different in step S512 (NO in step S603), and the connection target network is the second network (the second NW in step S605). Thus, the PC 101 is disconnected from wireless connection to the AP 104, and is directly connected to the printer 102 using the direct connection setting information acquired in step S506 (step S607).

As the network communication processing in step S512, the setup application transmits print data of test printing to the printer 102 (step S604). The printer 102 executes printing based on the received print data. This allows the user to confirm that the setup of the printer 102 is complete and the printer 102 is in a printable state.

The above processing is the series of processes of the setup application from the start of the setup of the printer 102 until completion of registration in the Web service and the setup of the printer 102. According to this embodiment, even in a state in which the PC and the printer are not connected via the network, it is easy to perform the setup of the printer including network connection of the printer and registration in a specific Web service. That is, a change from direct connection to the infrastructure mode in step S509 (step S606) and a change from the infrastructure mode to direct connection in step S512 (step S607) are automatically performed after the processing of step S508 without any user operation of switching the connection destination. Therefore, while the setup of the printer is executed, the user who operates the information processing apparatus need not appropriately switch the connection destination of the information processing apparatus to the external apparatus or the printer.

### <Example of Sequence of Setup>

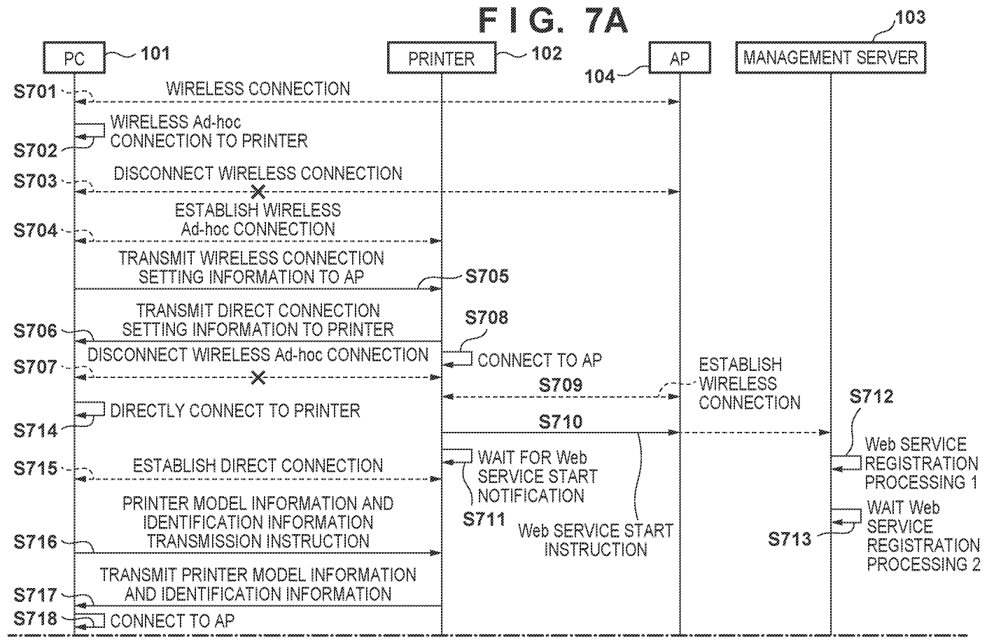

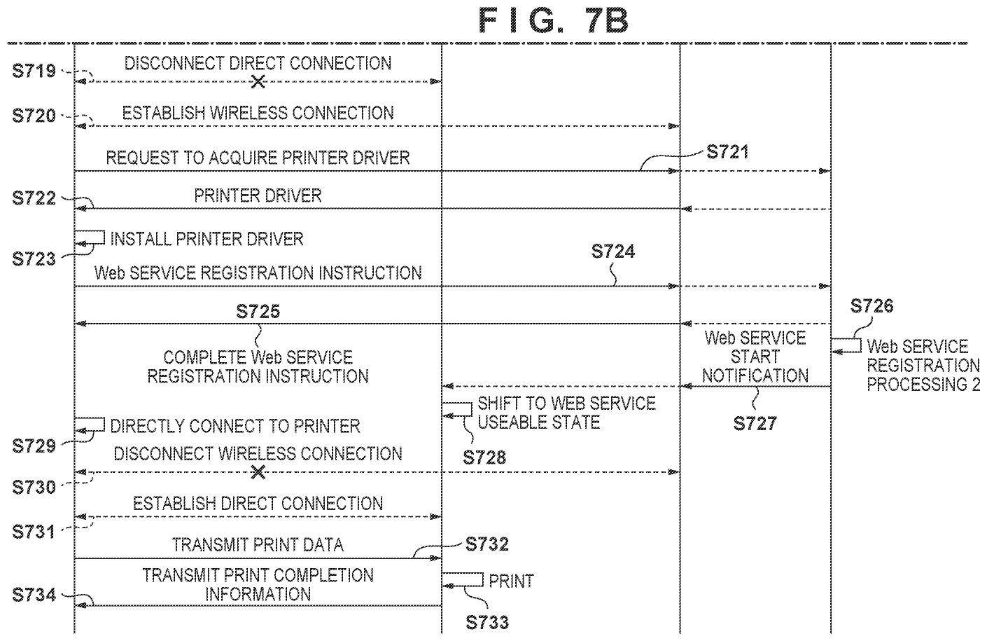

FIGS. 7A and 7B illustrate a sequence chart showing the procedure of processing among the PC 101, the printer 102, the management server 103, and the AP 104 when the setup application performs the operation shown in FIG. 5 according to the embodiment. In each apparatus, the CPU of the apparatus mainly executes processing.

Processes in S701 to S707, S714 to S725, and S729 to S734 correspond to steps S501 to S512 of the flowchart shown in FIG. 5 and a description thereof will be omitted. In this example, in S701 to S707, processes corresponding to steps S501 to S506 of FIG. 5 are executed. Subsequently, in S708 and S709, the printer 102 is wirelessly connected to the AP 104. A series of processes from when the printer 102 becomes connectable to the Internet 100 until the printer 102 shifts to the Web service usable state will be described.

In S710, the printer 102 transmits a Web service start instruction to the management server 103. More specifically, the printer 102 communicates with the management server 103 via the AP 104 to transmit information necessary for registration of the printer 102 in the Web service, including the identification information of the printer 102 such as a serial number.

In S711, the printer 102 shifts to a state in which it waits for a Web service start notification.

In S712, the management server 103 performs the first Web service registration processing. More specifically, the management server 103 collates the identification information acquired from the printer 102 in S710 with the pieces of identification information of a plurality of printers recorded in the database 413, and determines whether the matching identification information is registered.

If it is determined in S712 that the matching identification information is not registered, the management server 103 waits, in S713, for registration of the identification information of the printer 102 in the database 413, as the second Web service registration processing. For example, in the case of new registration, S713 is executed.

S714 to S725 correspond to steps S507 to S511 of FIG. 5. Note that in S724, the PC 101 transmits, as a Web service registration instruction, the identification information of the printer 102 such as a serial number to the management server 103 via the AP 104. In S725, the PC 101 receives, from the management server 103 via the AP 104, a response indicating that the Web service registration instruction has been accepted.

After receiving the Web service registration instruction in S724, the management server 103 performs the second Web service registration processing in S726. More specifically, the management server 103 records the identification information of the printer 102 in the database 413.

In S727, the management server 103 transmits information including the Web service start instruction to the printer 102 via the AP 104. This information may include contract information of the Web service to be started.

After acquiring the information including the Web service start instruction in S727, the printer 102 shifts to the Web service usable state in S728. Note that either the timing of recording the identification information of the printer 102 in the database 413 or the timing of transmitting information necessary for Web service registration from the printer 102 to the management server 103 can be first. If, for example, it is determined in S712 that the matching identification information is already registered, the management server 103 immediately transmits the information including the Web service start instruction to the printer 102. S729 to S734 correspond to step S512 of FIG. 5. In this way, even if communication between the printer and the information processing apparatus is limited to communication by P2P connection, the information processing apparatus can set the printer, install the driver, and register the printer in the support service.

Note that determination of the connection target network in steps S601 to S603 in this embodiment may be performed based on a response obtained by performing the target network communication processing for the currently connected network. For example, if the response indicates that the performed communication processing has succeeded, it may be determined that the currently connected network is the connection target network expected by each communication process. In this case, it may be determined that the network communication processing to be executed has succeeded. If the response indicating success is not obtained, the connection is switched to connection that is not currently performed out of direct connection to the printer 102 and wireless connection to the AP 104, and then the network communication processing to be executed is executed. In this case, if the response indicating that the communication has succeeded cannot be acquired for a predetermined time, it may be determined that there is no response indicating success, and then it is determined that the currently connection network is not the communication target network. In this method, it is possible to prevent the labor of adding a combination of contents of communication processing and connection target network information along with an increase in number of types of network communication processes executed during the setup.

Furthermore, the connection target network may be specified in step S601 in this embodiment by acquiring, via the Internet, a combination of the contents of the communication processing executed by the setup application and the connection target network information. In this method, even if the number of types of network communication processes executed during the setup increases, it is possible to add a combination of the contents of network communication processing and the connection target network information by updating a file online. Therefore, it is possible to cope with this without changing the setup application.

### Modification

The first embodiment has explained the example in which the client terminal and the printer are connected to the same network via the access point, and the so-called privacy separator function restricts communication. The present invention is not limited to this and communication between devices connected to different wireless networks is often normally restricted. Even in this arrangement, by applying the invention according to this embodiment, the information processing apparatus can register and set the printer connected to a network different from a wireless network connected to the information processing apparatus.

As an example, for example, even if the printer is connected to a wired LAN and the information processing apparatus has no wired LAN interface, the first embodiment can be applied. In this arrangement, the wired LAN and the wireless LAN are different networks, and communication between devices in the respective networks is often restricted. In this case, the printer is connected to the wired LAN, and thus it is unnecessary to transmit, to the printer, the connection setting information to the AP but the remaining procedure may be the same as in the first embodiment. Furthermore, in this case, the wireless network connected to the printer may be only the second network. Therefore, the printer need not perform simultaneous connection, and thus the wireless network between the information processing apparatus and the printer need not be direct connection and may be ad hoc connection.

If the information processing apparatus is a smartphone or a tablet terminal, it is unnecessary to install the printer driver. If the information processing apparatus has, for example, a general-purpose printer driver and uses it, it is unnecessary to install the printer driver. In this case, a procedure of acquiring the printer driver from the server and installing it is unnecessary. The remaining procedure may be the same as in the first embodiment.

As described above, even if the printer having the wireless LAN function is connected to the wired LAN, the information processing apparatus can register and set the printer by applying the invention according to the first embodiment.

### Other Embodiments

Referring to FIG. 5, since the order of the network communication processes to be executed is decided as the order of steps S509, S511, and S512, a network connected to a PC 101 and a connection target network are confirmed before execution of each step. Therefore, without performing the specifying processes of steps S601 and S602 of FIG. 6 and the determination processes of steps S603 and S605 of FIG. 6, the PC 101 may appropriately be connected to an appropriate network in a predetermined order. This can perform the processing by switching the network to be connected, as needed, while reducing redundant processing. FIG. 8 shows the procedure. In a flowchart shown in FIG. 8, the same reference symbols as in FIG. 5 denote the same steps and a description thereof will be omitted. A system configuration, the arrangement of each apparatus, and the like are the same as in the above-described embodiment.

Following step S508, in step S801, the PC 101 establishes wireless connection to an AP 104. Then, the PC 101 requests, via the AP 104, a printer driver compatible with a printer 102 from a management server 103, and acquires it in step S802. Steps S801 and S802 correspond to the first network communication processing.

After installing the acquired printer driver in step S510, the PC 101 registers, in step S803, the printer 102 in a Web service provided by the management server 103. Step S803 corresponds to the second network communication processing.

After the completion of the registration, the PC 101 establishes direct connection to the printer 102 in step S804, and executes test printing in step S805. Step S805 corresponds to the third network communication processing.

In the above procedure, versatility realized in FIG. 6 is lost but the procedure is simple, thereby making it possible to implement quick processing. The effect obtained in the above embodiment is also maintained.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-065899, filed Apr. 13, 2023 which is hereby incorporated by reference herein in its entirety.

What is claimed is:

1. A non-transitory computer-readable storage medium storing one or more programs configured to cause at least one memory and at least one processor of an information processing apparatus to function as:
a first communication control unit configured to perform control to perform wireless communication with a communication apparatus by a first communication method of performing communication without intervention of an external access point;
an acquisition unit configured to acquire, from the communication apparatus, specification information for specifying the communication apparatus by communication of the first communication method;
a second communication control unit configured to perform control to start, after the acquisition unit acquires the specification information, wireless communication of a second communication method as a communication method via the external access point; and
a first transmission control unit configured to perform control to transmit the specification information acquired by the acquisition unit to a specific server system connected to an external network by the communication of the second communication method started by the control of the second communication control unit.

2. The storage medium storing the one or more programs according to claim 1, wherein the first communication method is a communication method of performing communication via a wireless LAN interface.

3. The storage medium storing the one or more programs according to claim 1, wherein the first communication method is Wi-Fi Direct.

4. The storage medium storing the one or more programs according to claim 1, wherein the first communication method is a communication method in which the communication apparatus functions as one of a group owner and an access point.

5. The storage medium storing the one or more programs according to claim 1, wherein the second communication control unit controls to start wireless communication of the second communication method even in a case where a user does not perform a connection destination switching operation after the acquisition unit acquires the specification information.

6. The storage medium storing the one or more programs according to claim 1, wherein the second communication control unit controls to disconnect communication of the first communication method and to perform communication of the second communication method.

7. The storage medium storing the one or more programs according to claim 1, wherein
the communication apparatus serves as a printer, and
wherein the at least one memory and the at least one processor are further caused to function as
a control unit configured to perform control to acquire a driver of the communication apparatus by the communication of the second communication method started by the control of the second communication control unit, and install the driver in the information processing apparatus.

8. The storage medium storing the one or more programs according to claim 1, wherein the at least one memory and the at least one processor are further caused to function as
a third communication control unit configured to perform control to start communication of the first communication method with the communication apparatus after transmitting the specification information to the specific server system under the control of the first transmission control unit, and
a second transmission control unit configured to perform control to transmit, to the communication apparatus, data for causing the communication apparatus to perform specific processing, by the communication of the first communication method started by the control of the third communication control unit.

9. The storage medium storing the one or more programs according to claim 8, wherein the communication apparatus serves as a printer, the specific processing is test printing, and the data is print data.

10. The storage medium storing the one or more programs according to claim 8, wherein the third communication control unit controls to disconnect the communication of the second communication method and to perform communication of the first communication method.

11. The storage medium storing the one or more programs according to claim 8, wherein
the first communication control unit controls to start wireless communication of the first communication method with the communication apparatus in a state in which the information processing apparatus is connected to the communication apparatus by a third communication method as wireless ad hoc connection, and
the communication apparatus can simultaneously perform connection by the first communication method and connection by the second communication method.

12. The storage medium storing the one or more programs according to claim 11, wherein the first communication unit controls to start wireless communication of the first communication method with the communication apparatus using connection information received from the communication apparatus by communication of the third communication method.

13. The storage medium storing the one or more programs according to claim 1, wherein the at least one memory and the at least one processor are further caused to function as
a third transmission control unit configured to perform control to transmit, to the communication apparatus, setting information for performing connection to an external access point, by a communication method of performing communication without intervention of the external access point, and
wherein the control of the second communication control unit is executed after the control of the third transmission control unit.

14. The storage medium storing the one or more programs according to claim 1, wherein the control of the second communication control unit and the control of the first transmission control unit are executed in a restricted state in which communication between the communication apparatus and the information processing apparatus via the external access point is restricted.

15. The storage medium storing the one or more programs according to claim 14, wherein the restricted state is a state in which a privacy separator function is enabled in the external access point.

16. The storage medium storing the one or more programs according to claim 1, wherein the control of the second communication control unit and the control of the first transmission control unit are executed as part of a series of processes for a setup of the communication apparatus.

17. The storage medium storing the one or more programs according to claim 1, wherein the control of the first transmission control unit is control to register the communication apparatus in a specific Web service.

18. The storage medium storing the one or more programs according to claim 17, wherein the communication apparatus serves as a printer, and at least one of printing and scanning in the communication apparatus cannot be used in a state in which the printer is not registered in the specific Web service.

19. An information processing apparatus comprising at least one memory and at least one processor and/or at least one circuit which function as:
a first communication control unit configured to perform control to perform wireless communication with a communication apparatus by a first communication method of performing communication without intervention of an external access point;
an acquisition unit configured to acquire, from the communication apparatus, specification information for specifying the communication apparatus by communication of the first communication method;
a second communication control unit configured to perform control to start, after the acquisition unit acquires the specification information, wireless communication of a second communication method as a communication method via the external access point; and
a first transmission control unit configured to perform control to transmit the specification information acquired by the acquisition unit to a specific server system connected to an external network by the communication of the second communication method started by the control of the second communication control unit.

20. A communication control method for an information processing apparatus that communicates with an external apparatus, the method comprising:
controlling to perform wireless communication with a communication apparatus by a first communication method of performing communication without intervention of an external access point;
acquiring, from the communication apparatus, specification information for specifying the communication apparatus by communication of the first communication method;
controlling to start, after the specification information is acquired, wireless communication of a second communication method as a communication method via the external access point; and
controlling to transmit the acquired specification information to a specific server system connected to an external network by the started communication of the second communication method.
